(19) United States
(12) Patent Application Publication
(10) Pub. No.: US 2024/0067339 A1
(43) Pub. Date: Feb. 29, 2024

(54) CONTROL APPARATUS, CONTROL METHOD, AND NON-TRANSITORY COMPUTER READABLE MEDIUM

(71) Applicant: TOYOTA JIDOSHA KABUSHIKI KAISHA, Aichi-ken (JP)

(72) Inventors: Ryotaro FUJIWARA, Tokyo-to (JP); Hirotada NAKANISHI, Toyota-shi (JP); Fuhito KODAMA, Nagoya-shi (JP); Yuki UCHIDA, Iwakura-shi (JP); Satoshi KOMAMINE, Nagoya-shi (JP); Yoshinori OKADA, Okazaki-shi (JP); Satoshi HIRANO, Obu-shi (JP)

(21) Appl. No.: 18/455,630

(22) Filed: Aug. 25, 2023

(30) Foreign Application Priority Data
Aug. 26, 2022 (JP) 2022-135350

(51) Int. Cl. B64D 1/18; A01M 7/00; A01M 9/00; G05D 1/10

(52) U.S. Cl. CPC B64D 1/18; A01M 7/0089; A01M 9/0092; G05D 1/101; B64U 10/13

(57) ABSTRACT

A control apparatus includes a controller configured to acquire weather information including a wind speed on a scheduled spraying date and time at which an unmanned aircraft is to spray an agricultural chemical on a field, determine a flight altitude of the unmanned aircraft according to the wind speed, and generate a plan for spraying of the agricultural chemical by the unmanned aircraft, the plan for spraying including the determined flight altitude.

### CROSS-REFERENCE TO RELATED APPLICATION

This application claims priority to Japanese Patent Application No. 2022-135350 filed on Aug. 26, 2022, the entire contents of which are incorporated herein by reference.

### TECHNICAL FIELD

The present disclosure relates to a control apparatus, a control method, and a program.

### BACKGROUND

Technology related to methods of aerially spraying granular compositions for agriculture is known. For example, Patent Literature (PTL) 1 discloses an aerial spraying method that can reduce drift, even when the wind is blowing, after aerial dropping of a granular composition for agriculture by using a powered sprayer mounted on an aircraft, such as a drone.

### CITATION LIST

### Patent Literature

PTL 1: JP 2021-058164 A

### SUMMARY

The technology for aerial spraying of agricultural chemicals using unmanned aircraft is susceptible to weather conditions and has room for improvement.

It would be helpful to improve technology for aerial spraying of agricultural chemicals using unmanned aircraft.

A control apparatus according to an embodiment of the present disclosure is a control apparatus including a controller configured to:
acquire weather information including a wind speed on a scheduled spraying date and time at which an unmanned aircraft is to spray an agricultural chemical on a field;
determine a flight altitude of the unmanned aircraft according to the wind speed; and
generate a plan for spraying of the agricultural chemical by the unmanned aircraft, the plan for spraying including the determined flight altitude.

A control method according to an embodiment of the present disclosure is a control method to be executed by a computer, the control method including:
acquiring weather information including a wind speed on a scheduled spraying date and time at which an unmanned aircraft is to spray an agricultural chemical on a field;
determining a flight altitude of the unmanned aircraft according to the wind speed; and
generating a plan for spraying of the agricultural chemical by the unmanned aircraft, the plan for spraying including the determined flight altitude.

A program according to an embodiment of the present disclosure is configured to cause a computer to execute operations, the operations including:
acquiring weather information including a wind speed on a scheduled spraying date and time at which an unmanned aircraft is to spray an agricultural chemical on a field;
determining a flight altitude of the unmanned aircraft according to the wind speed; and
generating a plan for spraying of the agricultural chemical by the unmanned aircraft, the plan for spraying including the determined flight altitude.

According to an embodiment of the present disclosure, technology for aerial spraying of agricultural chemicals using unmanned aircraft can be improved.

### BRIEF DESCRIPTION OF THE DRAWINGS

In the accompanying drawings:

FIG. 1 is a block diagram illustrating a schematic configuration of a system according to a first embodiment;

FIG. 2 is a diagram illustrating an example of an initial plan for spraying;

FIG. 3A is a diagram illustrating an example of an area in a field in which an unmanned aircraft sprays an agricultural chemical;

FIG. 3B is a diagram illustrating an example of an area in a field in which an unmanned aircraft sprays an agricultural chemical;

FIG. 4A is a flowchart illustrating operations of a control apparatus according to the first embodiment;

FIG. 4B is a flowchart illustrating operations of the control apparatus according to the first embodiment;

FIG. 5 is a diagram illustrating an example of a plan for spraying generated by the control apparatus;

FIG. 6A is a flowchart illustrating operations of a control apparatus according to a second embodiment; and

FIG. 6B is a flowchart illustrating operations of the control apparatus according to the second embodiment.

### DETAILED DESCRIPTION

### First Embodiment

Hereinafter, a first embodiment of the present disclosure will be described.

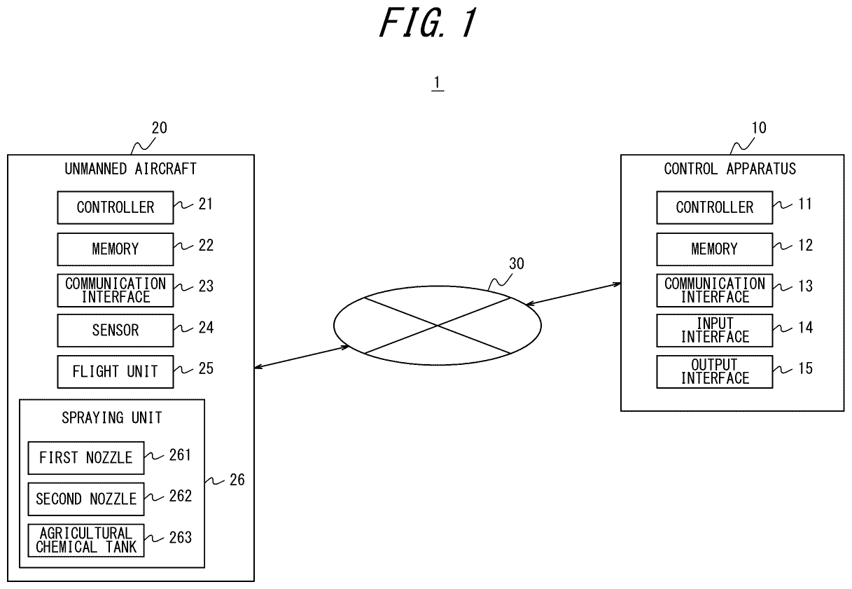

An outline of a system 1 according to an embodiment of the present disclosure will be described with reference to FIG. 1. The system 1 includes a control apparatus 10 and an unmanned aircraft 20. The control apparatus 10 and the unmanned aircraft 20 are communicably connected to a network 30 including, for example, the Internet. Although only one unmanned aircraft 20 is depicted in FIG. 1 for simplicity, there may be a plurality of unmanned aircraft 20.

The control apparatus 10 is installed in a facility such as a data center. The control apparatus 10 is, for example, a server that belongs to a cloud computing system or another type of computing system.

The unmanned aircraft 20 is any aircraft without a person on board. For example, an aircraft such as a drone or a multicopter can be employed as the unmanned aircraft 20. The unmanned aircraft 20 is, for example, used by a user acting as an agent who sprays agricultural chemicals on behalf of the manager of a field. The unmanned aircraft 20 includes a spraying apparatus for spraying agricultural chemicals from the sky towards the ground, either autonomously or in cooperation with the control apparatus 10, and can thereby spray agricultural chemicals onto the field from the sky.

The network 30 includes the Internet, at least one WAN, at least one MAN, or a combination thereof. The term “WAN” is an abbreviation of wide area network. The term “MAN” is an abbreviation of metropolitan area network. The network 30 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

First, an outline of the present embodiment will be described, and details thereof will be described later. The control apparatus 10 acquires weather information including a wind speed on a scheduled spraying date and time at which the unmanned aircraft 20 is to spray an agricultural chemical on a field, determines a flight altitude of the unmanned aircraft 20 according to the wind speed, and generates a plan for spraying of the agricultural chemical by the unmanned aircraft 20, the plan for spraying including the determined flight altitude.

In the present embodiment, a request to reserve use of the unmanned aircraft 20 is made from the manager of a field to the control apparatus 10 in order to spray an agricultural chemical on the field. Specifically, reservation information indicating the content of the reservation is transmitted from the terminal apparatus or the like of the user to the control apparatus 10. The reservation information may include any information such as the date and time the use is scheduled, the target field, the type of agricultural chemical, and the desired type of unmanned aircraft 20. The control apparatus 10 generates a plan for spraying by the unmanned aircraft 20 based on the reservation information. As explained below, the plan for spraying includes information such as the scheduled spraying date and time for spraying the agricultural chemical, the target field for spraying, the flight altitude of the unmanned aircraft 20 during spraying, the particle size of droplets of the agricultural chemical, and the nozzle to be used by the unmanned aircraft 20.

According to the present embodiment, the control apparatus 10 can generate an appropriate plan for spraying for the unmanned aircraft 20, taking into account the weather and the like on the day of spraying of the target field. According to the plan for spraying, the agricultural chemical can be sprayed efficiently by the unmanned aircraft 20. The technology for aerial spraying of agricultural chemicals using unmanned aircraft can therefore be improved.

Next, a configuration of the control apparatus 10 included in the system 1 will be described in detail.

(Configuration of Control Apparatus)

As illustrated in FIG. 1, the control apparatus 10 includes a controller 11, a memory 12, a communication interface 13, an input interface 14, and an output interface 15.

The controller 11 includes at least one processor, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The dedicated circuit is, for example, an FPGA or an ASIC. The term “FPGA” is an abbreviation of field-programmable gate array. The term “ASIC” is an abbreviation of application specific integrated circuit. The controller 11 executes processes related to operations of the control apparatus while controlling components of the control apparatus 10.

The memory 12 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 12 functions as, for example, a main memory, an auxiliary memory, or a cache memory. The memory 12 stores information to be used for the operations of the control apparatus 10 and information obtained by the operations of the control apparatus 10. For example, the memory 12 may store a system program, an application program, a database, map information, or the like. The information stored in the memory 12 may be updated with, for example, information acquired from the network 30 via the communication interface 13. The memory 12 may store a reservation database that accumulates reservation information for the use of the unmanned aircraft 20.

The communication interface 13 includes at least one interface for communication. The interface for communication is, for example, a LAN interface. The communication interface 13 receives information to be used for the operations of the control apparatus 10 and transmits information obtained by the operations of the control apparatus 10.

The input interface 14 includes at least one interface for input. The interface for input is, for example, a physical key, a capacitive key, a pointing device, a touch screen integrally provided with a display, or a microphone. The input interface 14 accepts an operation for inputting data to be used for the operations of the control apparatus 10. Instead of being included in the control apparatus 10, the input interface 14 may be connected to the control apparatus 10 as an external input device. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 15 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 15 outputs data obtained by the operations of the control apparatus 10. Instead of being included in the control apparatus 10, the output interface 15 may be connected to the control apparatus 10 as an external output device. As the connection method, any technology such as USB, HDMI®, or Bluetooth® can be used.

The functions of the control apparatus 10 are realized by execution of a control program according to the present embodiment by a processor corresponding to the controller 11. That is, the functions of the control apparatus 10 are realized by software. The control program causes a computer to execute the operations of the control apparatus 10, thereby causing the computer to function as the control apparatus 10. That is, the computer executes the operations of the control apparatus 10 in accordance with the control program to thereby function as the control apparatus 10.

The program can be stored on a non-transitory computer readable medium. Examples of the non-transitory computer readable medium include a magnetic recording device, an optical disk, a magneto-optical storage device, and ROM. The program is distributed by sale, transfer of ownership, or rental of a portable medium, such as a DVD or a CD-ROM, in which the program is stored. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the control apparatus 10 may be realized by a programmable circuit or a dedicated circuit serving as the controller 11. That is, some or all of the functions of the control apparatus 10 may be realized by hardware.

Next, a configuration of the unmanned aircraft 20 included in the system 1 will be described in detail.

(Configuration of Unmanned Aircraft)

As illustrated in FIG. 1, the unmanned aircraft 20 includes a controller 21, a memory 22, a communication interface 23, a sensor 24, a flight unit 25, and a spraying unit 26.

The controller 21 includes at least one processor, at least one dedicated circuit, or a combination thereof. The processor is a general purpose processor such as a CPU or a GPU, or a dedicated processor that is dedicated to specific processing. The dedicated circuit is, for example, an FPGA or an ASIC. The controller 21 executes processes related to operations of the unmanned aircraft 20 while controlling the components of the unmanned aircraft 20.

The memory 22 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 22 functions as, for example, a main memory, an auxiliary memory, or a cache memory. The memory 22 stores data to be used for the operations of the unmanned aircraft 20 and data obtained by the operations of the unmanned aircraft 20.

The communication interface 23 includes at least one interface for communication. The interface for communication is, for example, an interface compliant with a mobile communication standard such as LTE, the 4G standard, or the 5G standard. The communication interface 23 receives data to be used for the operations of the unmanned aircraft 20 and transmits data obtained by the operations of the unmanned aircraft 20.

The sensor 24 includes a variety of sensors. The sensor 24 may include a positioning sensor, a distance measuring sensor, an azimuth sensor, an acceleration sensor, an angular velocity sensor, a ground altitude sensor, an obstacle sensor, and the like. The positioning sensor measures the position of the unmanned aircraft 20. The positioning sensor can detect an absolute position expressed in terms of latitude, longitude, and the like. The positioning sensor includes at least one GNSS receiver. GNSS is, for example, GPS, QZSS, BeiDou, GLONASS, or Galileo. The distance measuring sensor measures the distance to an object. The azimuth sensor detects a magnetic force of the geomagnetic field to measure the azimuth. For example, a gyro sensor is used as the acceleration sensor and the angular velocity. For example, an ultrasonic sensor or an infrared sensor is used as the ground altitude sensor and the obstacle sensor. The sensor 24 may further include a barometric pressure sensor.

The flight unit 25 includes a plurality of rotor blades and a drive unit therefor. The number of the rotor blades may be, for example, four or six, but the number is not limited thereto. For example, a plurality of rotary wings is radially arranged about the center of the body of the unmanned aircraft 20. The flight unit 25 adjusts the rotational speed of the rotor blades under the control of the controller 21 to cause the unmanned aircraft 20 to perform various motions, such as hovering, ascending, descending, moving forward, moving backward, and turning.

The spraying unit 26 includes a first nozzle 261, a second nozzle 262, and an agricultural chemical tank 263. The spraying unit 26 functions as a spraying apparatus for the unmanned aircraft 20 to spray an agricultural chemical. The first nozzle 261 ejects the agricultural chemical as droplets having a first particle size. The second nozzle 262 ejects the agricultural chemical as droplets having a second particle size larger than the first particle size. The first nozzle 261 and the second nozzle 262 each have a plurality of spraying holes on their respective ejection surfaces, and the agricultural chemical is ejected as droplets with a predetermined particle size by passing through the spraying holes.

The agricultural chemical tank 263 stores an agricultural chemical to be sprayed on the field. In the present embodiment, the agricultural chemical is in liquid form, but this configuration is not limiting, and the agricultural chemical may also be in solid form, such as powder or granular material. In a case in which the agricultural chemical is in solid form, the agricultural chemical with a first particle size and the agricultural chemical with a second particle size are stored in separate agricultural chemical tanks 263, the agricultural chemical with the first particle size can be ejected from the first nozzle 261, and the agricultural chemical with the second particle size can be ejected from the second nozzle 262. The controller 21 can eject the agricultural chemical by controlling any drive mechanism provided in the first nozzle 261 and the second nozzle 262. In a case in which the agricultural chemical is in solid form, such as powder or granular material, nozzles having a structure for powder or granular material may be adopted as the first nozzle 261 and the second nozzle 262.

In the present embodiment, the first nozzle 261 and the second nozzle 262 are connected to the agricultural chemical tank 263 by a water supply channel. A valve that can be opened and closed is provided inside the water supply channel. The valve is driven by electricity or the like, and the controller 11 can control the open/closed state of the valve. Under control of the valve by the controller 11, the agricultural chemical is supplied from the agricultural chemical tank 263 through the water supply channel to the first nozzle 261 or the second nozzle 262, and the agricultural chemical is ejected from the first nozzle 261 or the second nozzle 262, respectively. The water supply channel may branch towards the first nozzle 261 and the second nozzle 262, and the valve may enable spraying of the agricultural chemical from one of the first nozzle 261 and the second nozzle 262. This configuration is not limiting, and the ejection surfaces of the first nozzle 261 and the second nozzle 262 may be configured to overlap, as in the structure of a shower head, for example. One of the first nozzle 261 and the second nozzle 262 can then be rotated relative to the other to change the particle size of the agricultural chemical to be ejected.

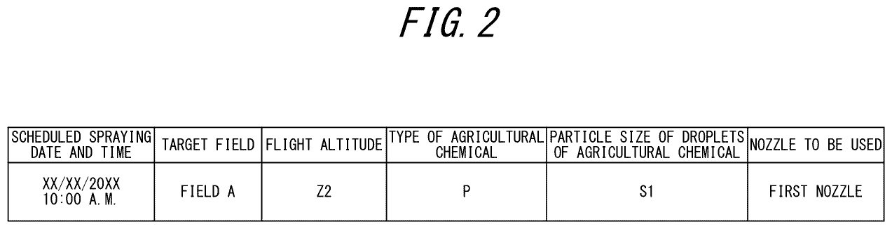

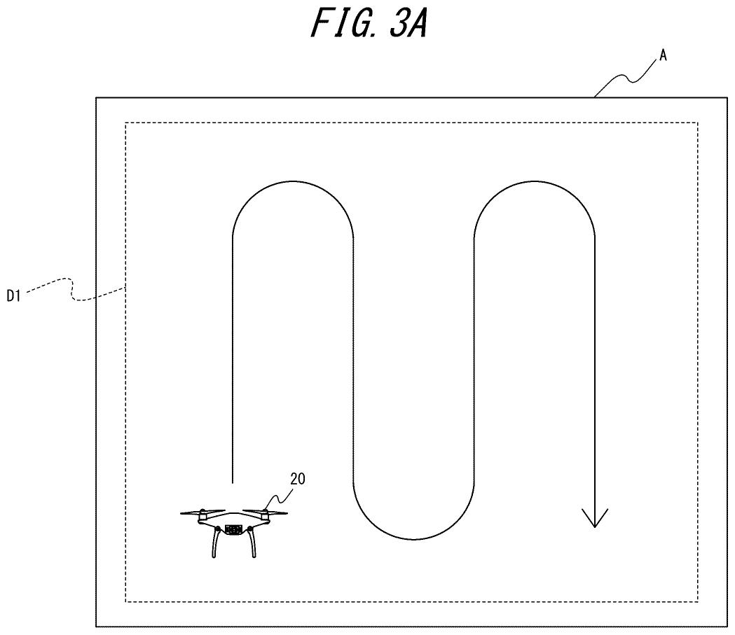

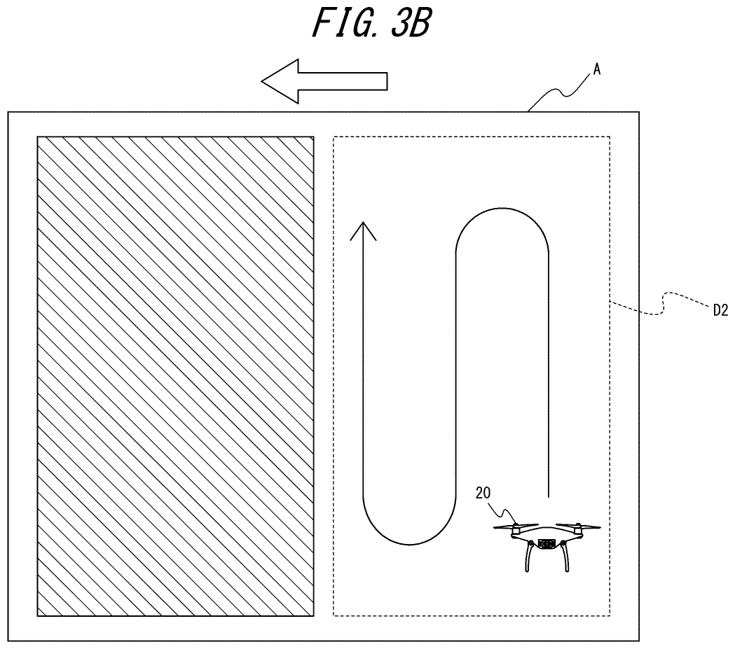

Operations of the control apparatus 10 according to the present embodiment will be described with reference to FIGS. 2 to 5. These operations correspond to a control method according to the present embodiment. FIG. 2 is a diagram illustrating an example of an initial plan for spraying. FIGS. 3A and 3B are diagrams illustrating an example of an area in a field in which the unmanned aircraft 20 sprays an agricultural chemical.

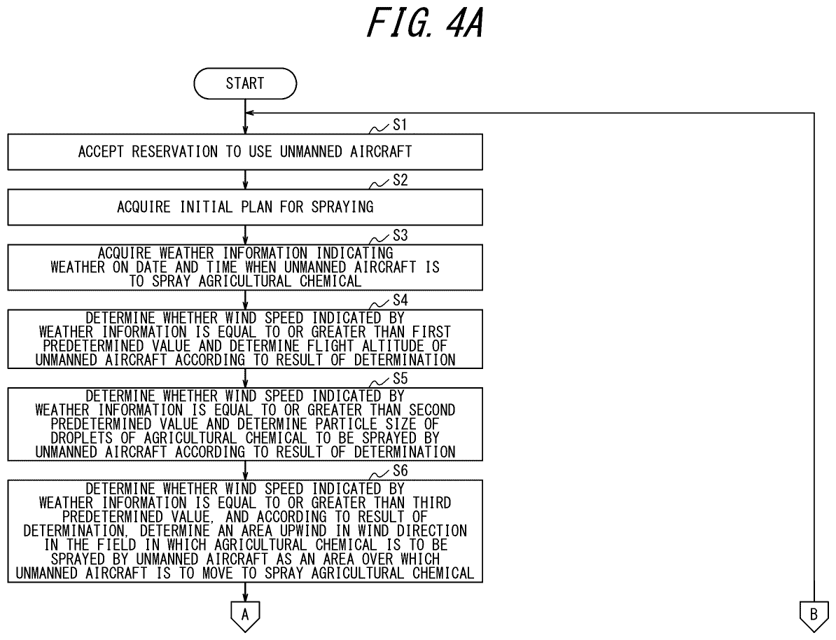

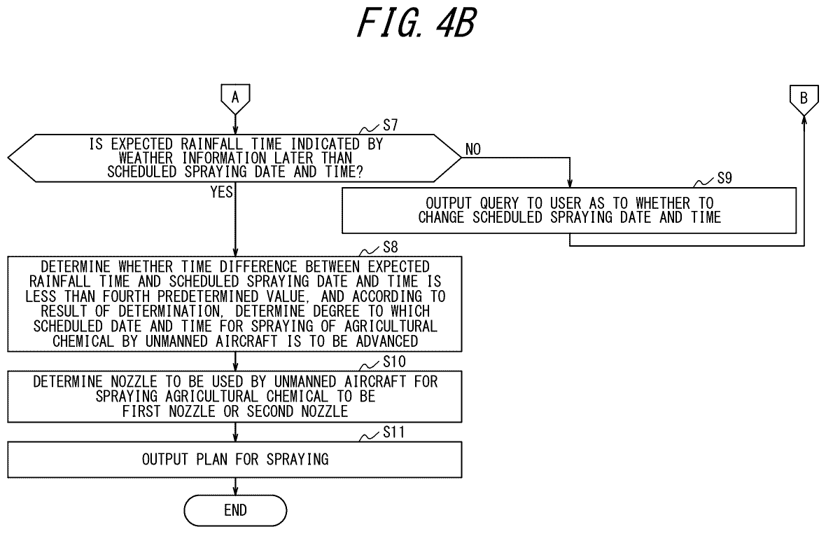

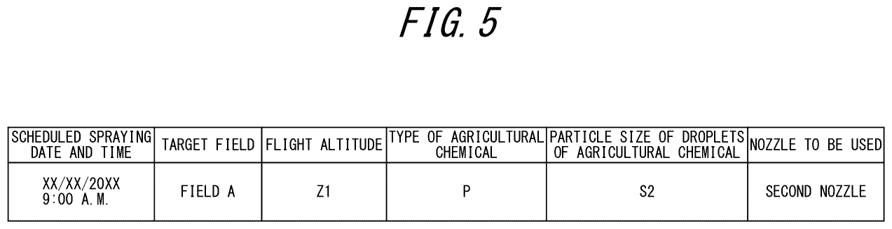

FIGS. 4A and 4B are flowcharts illustrating operations of the control apparatus 10. FIG. 5 is a diagram illustrating an example of a plan for spraying generated by the control apparatus 10. The control apparatus 10 is described below as transmitting and receiving information to and from each external apparatus via the communication interface 13 and the network 30.

In step S1 of FIG. 4A, the controller 11 accepts a reservation to use the unmanned aircraft 20. Any appropriate method may be used to accept the reservation. For example, the control apparatus 10 communicates with a terminal apparatus used by the manager of the field and accepts a reservation by receiving reservation information indicating the reservation details.

The reservation information includes the reservation date and time when the manager of the field wishes to use the unmanned aircraft 20, the field to be sprayed with the agricultural chemical, and the type of agricultural chemical. This configuration is not limiting, and the reservation information may include any information, such as a type of unmanned aircraft 20 designated by the manager of the field.

In step S2, the controller 11 acquires the initial plan for spraying. Any appropriate method may be used to acquire the initial plan for spraying. For example, the controller 11 may acquire the initial plan for spraying by generating the initial plan for spraying based on the reservation information and various pieces of information set in advance, such as the flight altitude of the unmanned aircraft 20.

FIG. 2 is a diagram illustrating an example of an initial plan for spraying. According to FIG. 2, the plan for spraying indicates that the unmanned aircraft 20 is to move over field A at a flight altitude Z2 at 10:00 a.m. on XX/XX/20XX and spray an agricultural chemical P with particle size S1 using the first nozzle 261. The plan for spraying may further include the route that the unmanned aircraft 20 will fly in field A to spray the agricultural chemical. For example, FIG. 3A illustrates the unmanned aircraft 20 moving in area D1 along the direction of the arrow in field A. The information included in the initial plan for spraying is not limited to this information. For example, the initial plan for spraying may include any information about the operation of the unmanned aircraft 20 during spraying of the agricultural chemical, such as the speed at which the unmanned aircraft 20 is moving.

In step S3, the controller 11 acquires weather information indicating the weather on the date and time when the unmanned aircraft 20 is to spray the agricultural chemical. Any appropriate method may be used to acquire the weather information. For example, the controller 11 may acquire the weather information by communicating with an external apparatus, such as a database of a weather observation center that predicts the weather for an area that includes the target field, and receiving the weather information from the database.

In the present embodiment, the weather information includes wind speed, wind direction, and expected rainfall time. This configuration is not limiting, and the weather information may include any information such as temperature or humidity.

In step S4, the controller 11 determines whether the wind speed indicated by the weather information is equal to or greater than a first predetermined value and determines the flight altitude of the unmanned aircraft 20 according to the result of the determination. The first predetermined value may be set freely. The first predetermined value may be different from or the same as the second predetermined value and the third predetermined value described below.

In the case of the wind speed indicated by the weather information being equal to or greater than the first predetermined value, the controller 11 determines a lower flight altitude than in the case of the wind speed being less than the first predetermined value. This is to prevent the site sprayed with the agricultural chemical from shifting from the intended site due to the wind. The flight altitude may be set freely taking into account the shift in the site that is sprayed. The controller 11 updates the flight altitude in the plan for spraying to the determined flight altitude. In a case in which no value has been entered in the initial plan for spraying, the controller 11 may enter the determined flight altitude as a new value. The same applies below in the case of updating the plan for spraying.

In the present embodiment, the wind speed indicated by the weather information is equal to or greater than the first predetermined value, and the controller 11 determines the flight altitude at which the unmanned aircraft 20 will fly to be Z1 and updates the flight altitude in the plan for spraying from Z2 to Z1. The processing by the controller 11 then proceeds to step S5.

As illustrated in steps S3 and S4, the controller 11 acquires weather information including the wind speed on the scheduled spraying date and time for the unmanned aircraft 20 to spray the agricultural chemical on the field and determines the flight altitude of the unmanned aircraft 20 according to the wind speed.

In step S5, the controller 11 determines whether the wind speed indicated by the weather information is equal to or greater than a second predetermined value and determines the particle size of the droplets of the agricultural chemical to be sprayed by the unmanned aircraft 20 according to the result of the determination. The second predetermined value may be set freely. In the case of the wind speed indicated by the weather information being equal to or greater than the second predetermined value, the controller 11 determines a larger particle size than in the case of the wind speed being less than the second predetermined value. This is to prevent the agricultural chemical from being blown away by the wind. The particle size may be set freely taking into account the effect of the wind. The controller 11 updates the particle size of the droplets of the agricultural chemical as included in the plan for spraying to the determined particle size.

In the present embodiment, the wind speed indicated by the weather information is equal to or greater than the second predetermined value, and the controller 11 determines that S2 is the particle size of the droplets of the agricultural chemical to be sprayed by the unmanned aircraft 20 and updates the particle size in the plan for spraying from S1 to S2. The processing by the controller 11 then proceeds to step S6.

As illustrated in step S5, the controller 11 determines the particle size of the droplets of the agricultural chemical to be sprayed by the unmanned aircraft 20 as the plan for spraying according to the wind speed indicated by the weather information. The controller 11 determines the particle size of the droplets of the agricultural chemical to be larger as the wind speed is greater.

In step S6, the controller 11 determines whether the wind speed indicated by the weather information is equal to or greater than a third predetermined value, and according to the result of the determination, determines an area upwind in the wind direction in the field in which the agricultural chemical is to be sprayed by the unmanned aircraft 20 as an area over which the unmanned aircraft 20 is to move to spray the agricultural chemical. The third predetermined value may be set freely. In a case in which the wind speed indicated by the weather information is equal to or greater than the third predetermined value, the controller 11 determines the upwind area in the field to be the area over which the unmanned aircraft 20 is to move. In a case in which the wind speed is less than the third predetermined value, the entire field may be determined to be the area over which the unmanned aircraft 20 is to move.

In the present embodiment, it is assumed that the wind speed indicated by the weather information is equal to or greater than the third predetermined value. In FIG. 3B, which represents field A, it is assumed that the wind direction indicated by the weather information is the direction indicated by the white arrow. In this case, the controller 11 determines the upwind area D2, as indicated by the dashed line in FIG. 3B, as the area over which the unmanned aircraft 20 is to move for spraying. The size and shape of the area determined as the “upwind area” in a case in which the wind speed is equal to or greater than the third predetermined value may be set freely. For example, the controller 11 may determine the farthest upwind area, among areas in the field A in which the unmanned aircraft 20 is to spray the agricultural chemical as illustrated in FIG. 3A, that has a predetermined area as the area over which the unmanned aircraft 20 is to move for spraying. The predetermined area may be any size, such as half, three-quarters, or the like of the area of the target field.

The controller 11 updates the area, in the field included in the plan for spraying, over which the unmanned aircraft 20 is to move for spraying the agricultural chemical to the determined area. In the present embodiment, it is assumed that the controller 11 has updated the area over which the unmanned aircraft 20 is to move for spraying the agricultural chemical from D1 in FIG. 3A to D2 in FIG. 3B. By the unmanned aircraft 20 not spraying the agricultural chemical over the hatched area in FIG. 3B, the possibility of the agricultural chemical being blown downwind from the field A can be reduced as compared to the case in which the agricultural chemical is sprayed over the area D1 in FIG. 3A, which also includes the hatched area. The hatched area is sprayed with a certain amount of the agricultural chemical from upwind. The processing by the controller 11 then proceeds to step S7.

As illustrated in step S6, the weather information includes the wind direction, and as the plan for spraying, the controller 11 determines an area upwind in the wind direction in the field in which the agricultural chemical is to be sprayed by the unmanned aircraft 20 as the area over which the unmanned aircraft 20 is to move to spray the agricultural chemical.

In step S7 of FIG. 4B, the controller 11 determines whether the expected rainfall time indicated by the weather information is later than the scheduled spraying date and time. In a case in which the expected rainfall time is later than the scheduled spraying date and time, the operation of the controller 11 advances to step S8, whereas in a case in which the expected rainfall time is earlier than the scheduled spraying date and time, the operation of the controller 11 advances to step S9.

In step S8, the controller 11 determines whether the time difference between the expected rainfall time and the scheduled spraying date and time is less than a fourth predetermined value, and according to the result of the determination, determines the degree to which the scheduled date and time for spraying of the agricultural chemical by the unmanned aircraft 20 is to be advanced. The fourth predetermined value may be set freely.

In a case in which the time difference is less than the fourth predetermined value, the controller 11 determines a value greater than the case of being equal to or greater than the fourth predetermined value as the degree to which the scheduled spraying date and time is to be advanced. The degree may be set freely. For example, the controller 11 may determine to advance the scheduled spraying date and time by 30 minutes in a case in which the time difference is equal to or greater than the fourth predetermined value and may determine to advance the scheduled spraying date and time by one hour in a case in which the rainfall is less than the fourth predetermined value. In this case, the controller 11 may refer to the reservation database stored in the memory 12 to determine whether an earlier scheduled spraying date and time overlaps with another reservation. In the case of overlap, the controller 11 may output a query to the user as to whether the agricultural chemical should be sprayed without changing the scheduled spraying date and time.

Next, the case in which the controller 11 determines in step S7 that the expected rainfall time is before the scheduled spraying date and time is explained. In step S9, the controller 11 outputs a query to the user as to whether to change the scheduled spraying date and time. In this case, the controller 11 may be configured to refer to the reservation database stored in the memory 12, detect a date and time at which a reservation can be accepted prior to the expected rainfall time, and suggest that date and time as a candidate. Operation by the controller 11 then returns to step S1. In the present embodiment, the expected rainfall time indicated by the weather information is later than the scheduled spraying date and time, the time difference between the expected rainfall time and the scheduled spraying date and time is less than the fourth predetermined value, and the controller 11 determines that the start time of spraying of the agricultural chemical should be advanced by one hour and updates the scheduled spraying date and time in the plan for spraying from 10 a.m. on XX/XX/20XX to 9 a.m. on XX/XX/20XX. The processing by the controller 11 then proceeds to step S10.

As illustrated in steps S7 through S9, the weather information includes the expected rainfall time, and the controller 11 determines the degree to which the scheduled spraying date and time is to be advanced according to the expected rainfall time.

In step S10, the controller 11 determines the nozzle to be used by the unmanned aircraft 20 for spraying the agricultural chemical to be the first nozzle 261 or the second nozzle 262 based on the particle size of the droplets of the agricultural chemical as determined in step S5. In the present embodiment, the unmanned aircraft 20 includes the first nozzle 261 that ejects the agricultural chemical as droplets having a first particle size and the second nozzle 262 that ejects agricultural chemicals as droplets having a second particle size larger than the first particle size.

For example, the controller 11 determines whether a particle size that is the same as, or within a predetermined range from, the particle size determined in step S5 corresponds to the first particle size or the second particle size. In a case of determining that the particle size determined in step S5 is the same as or within a predetermined range from the first particle size, the controller 11 determines the first nozzle 261 as the nozzle to be used by the unmanned aircraft 20 to spray the agricultural chemical. In a case of determining that the particle size determined in step S5 is the same as or within a predetermined range from the second particle size, the controller 11 determines the second nozzle 262 as the nozzle to be used by the unmanned aircraft 20 to spray the agricultural chemical. The controller 11 updates the nozzle to be used by the unmanned aircraft 20, as included in the plan for spraying, to the determined nozzle.

In the present embodiment, the controller 11 determines the second nozzle 262 as the nozzle to be used by the unmanned aircraft 20 for spraying the agricultural chemical and updates the nozzle used in the plan for spraying from the first nozzle 261 to the second nozzle 262. The processing by the controller 11 then proceeds to step S11.

In step S11, the controller 11 outputs the plan for spraying. FIG. 5 illustrates an example of the plan for spraying generated by the controller 11. It is clear from FIG. 5 that the initial plan for spraying in FIG. 2 has been updated to reflect the determinations made by the controller 11 in steps S4, S5, S6, S8, and S10. Any method may be used for output.

For example, the controller 11 may display the plan for spraying to the user via the output interface 15 or transmit the plan to the user's terminal apparatus via the communication interface 13. For example, the controller 11 may transmit the plan for spraying directly to the unmanned aircraft 20 via the communication interface 13. In this case, the controller 21 of the unmanned aircraft 20 can receive the plan for spraying, control the flight unit 25 and the spraying unit 26 based on the plan for spraying, move over the area of the field indicated by the plan for spraying, and spray the agricultural chemical using the determined nozzle. Thereafter, the operations by the controller 11 end.

As described above, the control apparatus 10 includes the controller 11 that acquires weather information including the wind speed on a scheduled spraying date and time at which the unmanned aircraft 20 is to spray an agricultural chemical on a field, determines the flight altitude of the unmanned aircraft 20 according to the wind speed, and generates a plan for spraying of the agricultural chemical by the unmanned aircraft 20, the plan for spraying including the determined flight altitude.

According to the present embodiment, in a case in which the wind speed is high on the scheduled spraying date and time for spraying the agricultural chemical, the flight altitude of the unmanned aircraft 20 can be lowered to reduce the possibility of the agricultural chemical being blown away by the wind. Technology for aerial spraying of agricultural chemicals using unmanned aircraft can be improved in that the amount of agricultural chemical that cannot be sprayed at the intended location can be reduced. As described above, in the control apparatus 10 according to the present embodiment, the controller 11 determines, according to the wind speed, the particle size of the droplets of the agricultural chemical to be sprayed by the unmanned aircraft 20 as the plan for spraying. The controller 11 determines the particle size of the droplets of the agricultural chemical to be larger as the wind speed is greater.

According to the present embodiment, the controller 11 can determine to increase the particle size of the droplets of the agricultural chemical to be used in a case in which the wind speed is high. In other words, in a case in which the wind is expected to be strong, the particle size of the droplets of the agricultural chemical can be automatically determined to be a particle size that is less prone to being blown away by the wind. The flexibility in determining the particle size of the droplets of the agricultural chemical in response to wind speed achieves efficient use of the unmanned aircraft 20. The technology for aerial spraying of agricultural chemicals using unmanned aircraft can therefore be improved.

As described above, the unmanned aircraft 20 according to the present embodiment includes the first nozzle 261 that ejects the agricultural chemical as droplets having a first particle size and the second nozzle 262 that ejects agricultural chemicals as droplets having a second particle size larger than the first particle size. The controller 11 of the control apparatus 10 determines the nozzle to be used by the unmanned aircraft 20 for spraying the agricultural chemical to be the first nozzle 261 or the second nozzle 262 based on the determined particle size.

According to the present embodiment, the nozzle to be used by the unmanned aircraft 20 can be automatically selected according to the weather conditions on the day the agricultural chemical is to be sprayed, thereby achieving efficient spraying of the agricultural chemical. The technology for aerial spraying of agricultural chemicals using unmanned aircraft can therefore be improved.

As described above, in the control apparatus 10 according to the present embodiment, the weather information includes the expected rainfall time, and the controller 11 determines the degree to which the scheduled spraying date and time is to be advanced according to the expected rainfall time.

According to the present embodiment, the closer the expected rainfall time is to the scheduled spraying date and time, the earlier spraying of the agricultural chemical begins, thus making it possible to dry the sprayed agricultural chemical before the rain falls. Technology for aerial spraying of agricultural chemicals using unmanned aircraft can be improved in that a plan for spraying can be flexibly created even in adverse weather conditions.

As described above, in the control apparatus 10 according to the present embodiment, the weather information includes the wind direction, and the controller 11 determines an area upwind in the wind direction in the field in which the agricultural chemical is to be sprayed by the unmanned aircraft as the area over which the unmanned aircraft 20 is to move to spray the agricultural chemical.

According to the present embodiment, the area in the field over which the unmanned aircraft 20 moves for spraying can be planned in advance, reducing the possibility of agricultural chemicals being sprayed outside of the field downwind. The technology for aerial spraying of agricultural chemicals using unmanned aircraft can therefore be improved.

### Second Embodiment

Hereinafter, a second embodiment of the present disclosure will be described. The configurations of the system 1 and each apparatus in the present embodiment are the same as those in the first embodiment, and thus descriptions thereof are omitted.

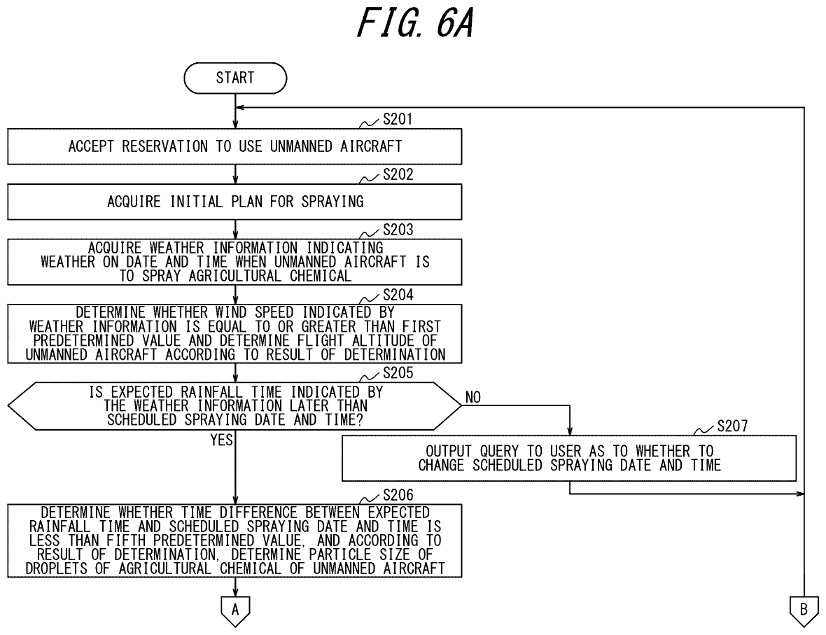

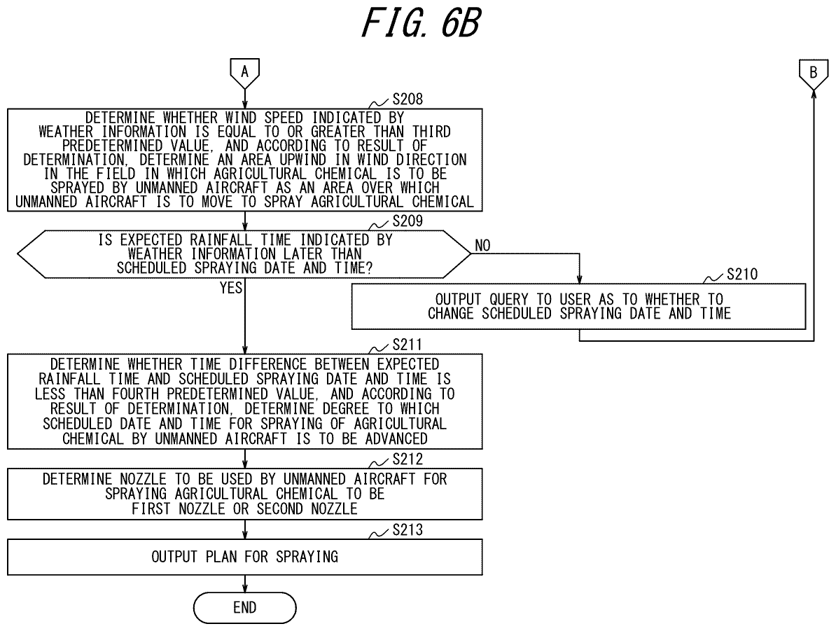

Operations of the controller 11 of the control apparatus 10 according to the second embodiment will be described with reference to FIGS. 6A and 6B. These operations correspond to a control method according to the present embodiment.

Steps S201 through S204 in FIG. 6A are similar to steps S1 through S4 in FIG. 4A of the first embodiment, and hence a description thereof is omitted.

In step S205, the controller 11 determines whether the expected rainfall time indicated by the weather information is later than the scheduled spraying date and time. In a case in which the expected rainfall time is later than the scheduled spraying date and time, the operation of the controller 11 advances to step S206, whereas in a case in which the expected rainfall time is earlier than the scheduled spraying date and time, the operation of the controller 11 advances to step S207.

In step S206, the controller 11 determines whether the time difference between the expected rainfall time and the scheduled spraying date and time is less than a fifth predetermined value, and according to the result of the determination, determines the particle size of the droplets of the agricultural chemical to be sprayed by the unmanned aircraft 20. The fifth predetermined value may be set freely.

In the case of the time difference being less than the fifth predetermined value, the controller 11 determines a smaller particle size than in the case of being equal to or greater than the fifth predetermined value. This is intended to allow the sprayed agricultural chemical to dry before the expected rainfall time. The particle size may be set freely, taking into account the speed at which the agricultural chemical dries. The controller 11 updates the particle size of the droplets of the agricultural chemical as included in the plan for spraying to the determined particle size.

Next, the case in which the controller 11 determines in step S205 that the expected rainfall time is before the scheduled spraying date and time is explained. In step S207, the controller 11 outputs a query to the user as to whether to change the scheduled spraying date and time. In this case, the controller 11 may be configured to refer to the reservation database stored in the memory 12, detect a scheduled spraying date and time at which a reservation can be accepted prior to the expected rainfall time, and suggest that date and time as a candidate. Operation by the controller 11 then re turns to step S201.

As illustrated in steps S205 through S207, the weather information includes the expected rainfall time, and as the plan for spraying, the controller 11 determines the particle size of the droplets of the agricultural chemical to be sprayed by the unmanned aircraft 20 according to the expected rainfall time. The controller 11 determines the particle size of the agricultural chemical to be smaller as the time difference between the scheduled spraying date and time and the expected rainfall time is smaller.

The controller 11 may combine the first embodiment with the present embodiment to determine the particle size of the droplets of the agricultural chemical. In this case, the user may freely set which particle size is prioritized, the one determined based on the wind speed or the one determined based on the expected rainfall time.

Steps S208 through S213 in FIG. 6B are similar to steps S6 in FIG. 4A through S11 in FIG. 4B of the first embodiment, and hence a description thereof is omitted.

As described above, in the control apparatus 10 according to the present embodiment, the weather information includes the expected rainfall time, and as the plan for spraying, the controller 11 determines the particle size of the droplets of the agricultural chemical to be sprayed by the unmanned aircraft 20 according to the expected rainfall time. The controller 11 determines the particle size of the droplets of the agricultural chemical to be smaller as the time difference between the scheduled spraying date and time and the expected rainfall time is smaller.

According to the present embodiment, the controller 11 can determine to decrease the particle size of the droplets of the agricultural chemical as the expected rainfall time is closer. In a case in which rain is expected in the near future, it can be automatically determined to reduce the particle size of the droplets of the agricultural chemical for quick drying after the spraying and before the rainfall. Technology for aerial spraying of agricultural chemicals using unmanned aircraft can be improved in that the particle size of the droplets of the agricultural chemical can be determined flexibly according to the expected rainfall time.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided. For example, an embodiment in which the configuration and operations of the control apparatus 10 in the above embodiment are distributed to multiple computers capable of communicating with each other can be implemented.

The above configurations are not limiting, and the controller 11 may be configured to determine, according to the information included in the weather information, the particle size of the droplets of the agricultural chemical so that the agricultural chemical to be sprayed will dry easily. For example, in a case in which the weather information includes temperature, the controller 11 may determine the particle size of the droplets of the agricultural chemical to be sprayed to be larger as the temperature is higher. For example, in a case in which the weather information includes humidity, the controller 11 may determine the particle size of the droplets of the agricultural chemical to be sprayed to be smaller as the humidity is higher.

Examples of some embodiments of the present disclosure are described below. However, it should be noted that the embodiments of the present disclosure are not limited to these examples.

[Appendix 1] A control apparatus comprising a controller configured to:
acquire weather information including a wind speed on a scheduled spraying date and time at which an unmanned aircraft is to spray an agricultural chemical on a field;
determine a flight altitude of the unmanned aircraft according to the wind speed; and
generate a plan for spraying of the agricultural chemical by the unmanned aircraft, the plan for spraying including the determined flight altitude.
   [Appendix 2] The control apparatus according to appendix 1, wherein the controller is configured to determine, according to the wind speed, a particle size of droplets of the agricultural chemical to be sprayed by the unmanned aircraft as the plan for spraying.
   [Appendix 3] The control apparatus according to appendix 1 or 2, wherein the controller is configured to determine the particle size of the droplets of the agricultural chemical to be larger as the wind speed is greater.
   [Appendix 4] The control apparatus according to any one of appendices 1 to 3, wherein the weather information includes an expected rainfall time, and the controller is configured to determine, according to the expected rainfall time, a particle size of droplets of the agricultural chemical to be sprayed by the unmanned aircraft as the plan for spraying.
   [Appendix 5] The control apparatus according to any one of appendices 1 to 4, wherein the controller is configured to determine the particle size of the droplets of the agricultural chemical to be smaller as a time difference between the scheduled spraying date and time and the expected rainfall time is smaller.
   [Appendix 6] The control apparatus according to any one of appendices 1 to 5, wherein
the unmanned aircraft comprises a first nozzle configured to eject the agricultural chemical as droplets having a first particle size and a second nozzle configured to eject the agricultural chemical as droplets having a second particle size larger than the first particle size, and
the controller is configured to determine a nozzle to be used by the unmanned aircraft for spraying the agricultural chemical to be the first nozzle or the second nozzle based on the determined particle size.
   [Appendix 7] The control apparatus according to any one of appendices 1 to 6, wherein the weather information includes an expected rainfall time, and the controller is configured to determine, according to the expected rainfall time, a degree to which the scheduled spraying date and time is to be advanced.
   [Appendix 8] The control apparatus according to any one of appendices 1 to 7, wherein the weather information includes a wind direction, and the controller is configured to determine an area upwind in the wind direction in a field in which the agricultural chemical is to be sprayed by the unmanned aircraft as an area over which the unmanned aircraft is to move to spray the agricultural chemical.
   [Appendix 9] A control method to be executed by a computer, the control method comprising:
acquiring weather information including a wind speed on a scheduled spraying date and time at which an unmanned aircraft is to spray an agricultural chemical on a field;
determining a flight altitude of the unmanned aircraft according to the wind speed; and
generating a plan for spraying of the agricultural chemical by the unmanned aircraft, the plan for spraying including the determined flight altitude.
   [Appendix 10] The control method according to appendix 9, further comprising determining, according to the wind speed, a particle size of droplets of the agricultural chemical to be sprayed by the unmanned aircraft as the plan for spraying.
   [Appendix 11] The control method according to appendix 9 or 10, further comprising determining the particle size of the droplets of the agricultural chemical to be larger as the wind speed is greater.
   [Appendix 12] The control method according to any one of appendices 9 to 11, wherein the weather information includes an expected rainfall time, and the control method further comprises determining, according to the expected rainfall time, a particle size of droplets of the agricultural chemical to be sprayed by the unmanned aircraft as the plan for spraying.
   [Appendix 13] The control method according to any one of appendices 9 to 12, further comprising determining the particle size of the droplets of the agricultural chemical to be smaller as a time difference between the scheduled spraying date and time and the expected rainfall time is smaller.
   [Appendix 14] The control method according to any one of appendices 9 to 13, wherein
the unmanned aircraft comprises a first nozzle configured to eject the agricultural chemical as droplets having a first particle size and a second nozzle configured to eject the agricultural chemical as droplets having a second particle size larger than the first particle size, and
the control method further comprises determining a nozzle to be used by the unmanned aircraft for spraying the agricultural chemical to be the first nozzle or the second nozzle based on the determined particle size.
   [Appendix 15] The control method according to any one of appendices 9 to 14, wherein the weather information includes an expected rainfall time, and the control method further comprises determining, according to the expected rainfall time, a degree to which the scheduled spraying date and time is to be advanced.
   [Appendix 16] A program configured to cause a computer to execute operations, the operations comprising:
acquiring weather information including a wind speed on a scheduled spraying date and time at which an unmanned aircraft is to spray an agricultural chemical on a field;
determining a flight altitude of the unmanned aircraft according to the wind speed; and
generating a plan for spraying of the agricultural chemical by the unmanned aircraft, the plan for spraying including the determined flight altitude.
   [Appendix 17] The program according to appendix 16, the operations further comprising determining, according to the wind speed, a particle size of droplets of the agricultural chemical to be sprayed by the unmanned aircraft as the plan for spraying.
   [Appendix 18] The program according to appendix 16 or 17, the operations further comprising determining the particle size of the droplets of the agricultural chemical to be larger as the wind speed is greater.
   [Appendix 19] The program according to any one of appendices 16 to 18, wherein the weather information includes an expected rainfall time, and the operations further comprise determining, according to the expected rainfall time, a particle size of droplets of the agricultural chemical to be sprayed by the unmanned aircraft as the plan for spraying.
   [Appendix 20] The program according to any one of appendices 16 to 19, the operations further comprising determining the particle size of the droplets of the agricultural chemical to be smaller as a time difference between the scheduled spraying date and time and the expected rainfall time is smaller.

1. A control apparatus comprising a controller configured to:
acquire weather information including a wind speed on a scheduled spraying date and time at which an unmanned aircraft is to spray an agricultural chemical on a field;
determine a flight altitude of the unmanned aircraft according to the wind speed; and
generate a plan for spraying of the agricultural chemical by the unmanned aircraft, the plan for spraying including the determined flight altitude.

2. The control apparatus according to claim 1, wherein the controller is configured to determine, according to the wind speed, a particle size of droplets of the agricultural chemical to be sprayed by the unmanned aircraft as the plan for spraying.

3. The control apparatus according to claim 2, wherein the controller is configured to determine the particle size of the droplets of the agricultural chemical to be larger as the wind speed is greater.

4. The control apparatus according to claim 1, wherein the weather information includes an expected rainfall time, and the controller is configured to determine, according to the expected rainfall time, a particle size of droplets of the agricultural chemical to be sprayed by the unmanned aircraft as the plan for spraying.

5. The control apparatus according to claim 4, wherein the controller is configured to determine the particle size of the droplets of the agricultural chemical to be smaller as a time difference between the scheduled spraying date and time and the expected rainfall time is smaller.

6. The control apparatus according to claim 1, wherein
the unmanned aircraft comprises a first nozzle configured to eject the agricultural chemical as droplets having a first particle size and a second nozzle configured to eject the agricultural chemical as droplets having a second particle size larger than the first particle size, and
the controller is configured to determine a nozzle to be used by the unmanned aircraft for spraying the agricultural chemical to be the first nozzle or the second nozzle based on the determined particle size.

7. The control apparatus according to claim 1, wherein the weather information includes an expected rainfall time, and the controller is configured to determine, according to the expected rainfall time, a degree to which the scheduled spraying date and time is to be advanced.

8. The control apparatus according to claim 1, wherein the weather information includes a wind direction, and the controller is configured to determine an area upwind in the wind direction in a field in which the agricultural chemical is to be sprayed by the unmanned aircraft as an area over which the unmanned aircraft is to move to spray the agricultural chemical.

9. A control method to be executed by a computer, the control method comprising:
acquiring weather information including a wind speed on a scheduled spraying date and time at which an unmanned aircraft is to spray an agricultural chemical on a field;
determining a flight altitude of the unmanned aircraft according to the wind speed; and
generating a plan for spraying of the agricultural chemical by the unmanned aircraft, the plan for spraying including the determined flight altitude.

10. The control method according to claim 9, further comprising determining, according to the wind speed, a particle size of droplets of the agricultural chemical to be sprayed by the unmanned aircraft as the plan for spraying.

11. The control method according to claim 10, further comprising determining the particle size of the droplets of the agricultural chemical to be larger as the wind speed is greater.

12. The control method according to claim 9, wherein the weather information includes an expected rainfall time, and the control method further comprises determining, according to the expected rainfall time, a particle size of droplets of the agricultural chemical to be sprayed by the unmanned aircraft as the plan for spraying.

13. The control method according to claim 12, further comprising determining the particle size of the droplets of the agricultural chemical to be smaller as a time difference between the scheduled spraying date and time and the expected rainfall time is smaller.

14. The control method according to claim 9, wherein
the unmanned aircraft comprises a first nozzle configured to eject the agricultural chemical as droplets having a first particle size and a second nozzle configured to eject the agricultural chemical as droplets having a second particle size larger than the first particle size, and
the control method further comprises determining a nozzle to be used by the unmanned aircraft for spraying the agricultural chemical to be the first nozzle or the second nozzle based on the determined particle size.

15. The control method according to claim 9, wherein the weather information includes an expected rainfall time, and the control method further comprises determining, according to the expected rainfall time, a degree to which the scheduled spraying date and time is to be advanced.

16. A non-transitory computer readable medium storing a program configured to cause a computer to execute operations, the operations comprising:
acquiring weather information including a wind speed on a scheduled spraying date and time at which an unmanned aircraft is to spray an agricultural chemical on a field;
determining a flight altitude of the unmanned aircraft according to the wind speed; and
generating a plan for spraying of the agricultural chemical by the unmanned aircraft, the plan for spraying including the determined flight altitude.

17. The non-transitory computer readable medium according to claim 16, wherein the operations further comprise determining, according to the wind speed, a particle size of droplets of the agricultural chemical to be sprayed by the unmanned aircraft as the plan for spraying.

18. The non-transitory computer readable medium according to claim 17, wherein the operations further comprise determining the particle size of the droplets of the agricultural chemical to be larger as the wind speed is greater.

19. The non-transitory computer readable medium according to claim 16, wherein the weather information includes an expected rainfall time, and the operations further comprise determining, according to the expected rainfall time, a particle size of droplets of the agricultural chemical to be sprayed by the unmanned aircraft as the plan for spraying.

20. The non-transitory computer readable medium according to claim 19, wherein the operations further comprise determining the particle size of the droplets of the agricultural chemical to be smaller as a time difference between the scheduled spraying date and time and the expected rainfall time is smaller.
